(19) United States
(12) Patent Application Publication
(10) Pub. No.: US 2001/0048206 A1
(43) Pub. Date: Dec. 6, 2001

(54) Rolling walker with load ensuring mechanism

(76) Inventors: Timothy O. Niu, Newton, MA (US); Douglas Eric Parsell, Ridgeland, MS (US)

Correspondence Address: Douglas Parsell, 327 Arlington Circle, Ridgeland, MS, 39157, US

(21) Appl. No.: 09/747,806

(22) Filed: Dec. 22, 2000

Related U.S. Application Data
(60) Provisional application No. 60/171,564, filed on Dec. 23, 1999.

(51) Int. Cl. A61H 3/04

(52) U.S. Cl. 280/87.021; 482/68

(57) ABSTRACT

The rolling walker with load assuring feedback disclosed herein provides unique features to benefit the recovery of convalescing patients with lower extremity or hip injury. Ensuring that the prescribed reduction in weight-bearing is occurring during walker ambulation is the goal of the walker disclosed herein. The walker is based on a rear-entry, four-wheeled design. The walker handles are loaded during usage to relieve stress from the injured body part. To give direct feedback to the user as to the adequateness of the applied handle loading, spring-loaded pistons allow the handles to reach a stable horizontal position only when adequate handle loading is produced. The load that is required to depress the handles to a horizontal position can be easily calibrated to match the prescribed weight removal through adjustment of the vertical position of the spring base. The various spring base positions that correlate with given required handle compression loads are marked on the piston housing for clinician convenience. An additional feature of the walker is a handle/cable/brake system whereby sufficient handle loading correlates with unbraking of the walker wheels. This feature both prevents the walker from unwanted rolling when the patient is not yet properly positioned within the walker and prevents walker movement during insufficient handle loading.

### RELATED APPLICATIONS

This application claims the benefit of priority to U.S. provisional application Ser. No. 60-171564, filed Dec. 23, 1999. For purposes of disclosure, the forgoing applications are incorporated herein by reference.

### BACKGROUND OF THE INVENTION

1. The Field of the Invention

The invention disclosed herein is in the field of walkers, more particularly the field of rehabilitation walkers. More particularly, the invention is in the field of rolling front entry walkers with mechanisms within the structure to ensure patient and medical personnel that proper loading of the walker frame by the patient occurs during patient use.

2. The Relevant Technology

In general, the healing rate of both hard and soft tissues of the human body occurs optimally at a specific mechanical loading range. If healing body structures are loaded too heavily, physical damage, impaired healing rates and resorption may occur. On the other hand, if healing body structures are shielded from loads excessively, diminished healing rates or even atrophy may occur.

The optimum mechanical loads for maximum healing rate depend mainly upon the stage of healing. In general, early stage healing is matched with maximum load shielding, while conversely, late stage healing is matched with closer to pre-injury applied loads. Ideally a continuum of heavier loads would be allowed to stress the healing tissues as the tissue repair process progressed from near post-trauma to full recovery.

The body structures of primary concern for sequential control of loading are those of the lower extremities. The weight of the individual's body must be distributed by means other than the individual's lower body during ambulation to avoid over stressing of healing tissues. Load control during ambulation is critically important for rehabilitation of orthopedic procedures of the lower extremities such as bone fusions, fracture fixations, ligament repair, or joint replacement.

The tools traditionally utilized by physical therapists for load relief of the lower extremities of patients are primarily walkers, crutches and canes. The main concerns for the patient and therapist are that the rehabilitation device be safe, stable, allows for correct posture and walking motion and provides for the prescribed relief of body weight load during ambulation. For patients without sufficient upper body strength or adequate balance, crutches and canes are not appropriate and walker devices must be utilized. The traditional “invalid” walker is designed with the device in front of the user, possibly as a means to intentionally encumber and slow the user. The primary goal of the invalid walker is that of control and stability, not partial unloading of the lower extremities and re-education of musculoskeletal systems. It is presently common to use of this type of walker for the population of patients recovering from various orthopedic procedures. The rationale for their usage is based simply on the current lack of more appropriately-designed, affordable, device options for this uniquely young and otherwise healthy patient population.

Traditional walkers provide for a safe and stable means for load protection of lower extremities during ambulation. However, the traditional design does have some shortcomings. Firstly, the traditional walker must be lifted, extended out in front of the user, and repositioned before the next steps may be taken. The physical demands of this action are especially straining to the lumbar region of the user's back. Rolling walkers have been introduced to eliminate this potential design danger (examples U.S. Pat. No 4,907,794 by Rose, U.S. Pat. No. 4,384,713 by Deutsch), where by wheels or coasters replace the rubber foot pads of the traditional walker.

The majority of walker designs, both static legged and roller, utilize an architecture that positions the framework of the walker in front and to the sides of the user. A primary shortcoming with this design for orthopedic rehabilitation utilization is the impedance of normal walking motion for the user. A vital part of the rehabilitation process is to re-educate the major and minor muscle groups to properly support skeletal structures during physiologically correct walking. When the walking motion is modified due to use of an assistive device, the musculoskeletal system is neither correctly loaded or trained for physiologically correct ambulation once the assistive device is removed from the user. For this reason, walker designs that allow for physiologically correct walking kinetics are critical for the rehabilitation of lower extremity recovering patients. The TheraTrek 1000 by UltiMedCo™ is an example of a rolling walker that allows for a correct posture during ambulation. U.S. Pat. No. 5,499,856 by Sorrell is another example of a front entry rolling walker. The dominant utilization of rolling front entry walkers is for pediatric patients. The utilization of this design for the rehabilitation of lower extremity trauma patients has been generally overlooked despite the aforementioned advantages.

Several walker systems have been designed that remove load from the ground-force experienced by the user during ambulation. These systems all have the common feature of a body harness that is attached to the frame of the walker in a manner such that linking spring elements are tensioned during normal usage. The tensioning of these spring elements, by the weight of the user's body, results in an upward force being applied to the body harness by the springs. This upward force reduces the ground-force experienced by the user during ambulation. The user is in effect partially suspended by the attached springs. Examples of these devices includes U.S. Pat. No. 5,174,590 by Kerley, U.S. Pat. No. 5,275,426 by Tankersley and U.S. Pat. No. 4,211,426 by Motloch. The main drawback of these systems is the cumbersome nature of the body harness. Typically the harnesses are time consuming and difficult to get into or out of and patients feel restricted or confined once strapped within. Harness systems also have a tendency to influence the users gait such that gait rehabilitation may be impeded.

As has been previously discussed, specific weight bearing levels are beneficial for patient recovery and these optimum weight bearing levels increase in proportion to the patient's recovery. The primary function of assistive devices, such as walkers, is to provide load relief during ambulation. What is unknown to both therapist and patient alike is how much load is being relieved from the patient's lower extremities during use of assistive devices such as walkers. Several devices have been developed to give feedback during ambulation to the therapist or patient concerning the amount of load that is being placed on lower extremities. The ForceGuard® Weight-Bearing System marketed by Smith&Nephew (Germantown, Wis.) is an electronic foot pad pressure sensor that emits and audio signal when applied pressure exceeds a set limit. Concerns with this system include high price, low durability, calibration concerns and that the system must be used in addition to a separate ambulation device. U.S. Pat. No. 5,311,880 by Lancaster reveals a device for electronically measuring the load, torque and rate of movement of a walker device primarily through the use of resistance wire strain detectors. This digital information can be subsequently analyzed for evaluation of walker utilization. Shortcomings of this system include high price, durability and no immediate feedback on applied loads to the patient. The lack of immediate feedback to the patient concerning load applied to the device greatly restricts the patient learning response, and therefore also greatly restricts patient device utilization performance. U.S. Pat. No. 5,020,560 by Turbeville reveals a tricycle formatted walker with brakes that disengage from the back wheels when the frame is loaded. Shortcomings of this system include a lack of means for load calibration, uneven loading of the frame (front to back) has the potential to allow ambulation at undesirably low device loading levels and a mechanically faulty load resistance adjustment mechanism. The inability for medical personnel to easily configure the device for prescribed load levels reduces the effectiveness of this device significantly.

It would be an improvement in the art to provide an integrated walker device that gives the user the needed stability and support for proper ambulation and also immediate tactile feedback as to ensure that a prescribed magnitude of load is exerted onto the walker frame during use. It would be an additional improvement in the art that such a device discouraged use when inadequately loaded. It would be an additional improvement in the art that such a device possessed excellent durability and a technological simplicity of design that allowed for low production costs. It would be an additional improvement in the art that such a device integrated a novel applied load regulating mechanism directly into the necessary structural framework of the walker as opposed to the user needing access to two separate devices, namely a walker device and a load feedback device.

Such devices for ensuring prescribed loading of an assistive ambulation system that allows for proper patient posture during use are disclosed and claimed herein.

### BRIEF SUMMARY AND OBJECTS OF THE INVENTION

In its preferred embodiment, the load ensuring rolling walker consists of a framework of tubular elements made from material or a combination of materials such as aluminum alloys, steel alloys, and/or composite polymers. These elements are joined through weld joins and/or nut and bolt fixation to form a three-sided framework that provides adequate structural support for the walker components such as wheels, braking system, load ensuring mechanisms, handles and lumbar support pads. A combination of tube diameters, wall thicknesses and compositions are utilized to yield a walker of both sufficient strength and low weight.

The unique features of the proposed design center around the concept that a clinically prescribed load reduction can be enforced through simple manipulation of features of the walker and that this enforced load reduction can be easily adjusted as the user's healing progresses. In its preferred embodiment, the load ensuring mechanism is linked to the walker's braking system for inhibiting movement of the walker prior to adequate loading.

The unique features of the proposed walker are incorporated in a front entry, four wheeled walker, thereby facilitating proper pelvic orientation and posture during the rehabilitation period. The walker is constructed such that the two parallel sides of the frame can be collapsed towards each other through a folding process of the perpendicular side of the frame for ease of storage.

### BRIEF DESCRIPTION OF SEVERAL VIEWS OF THE INVENTION

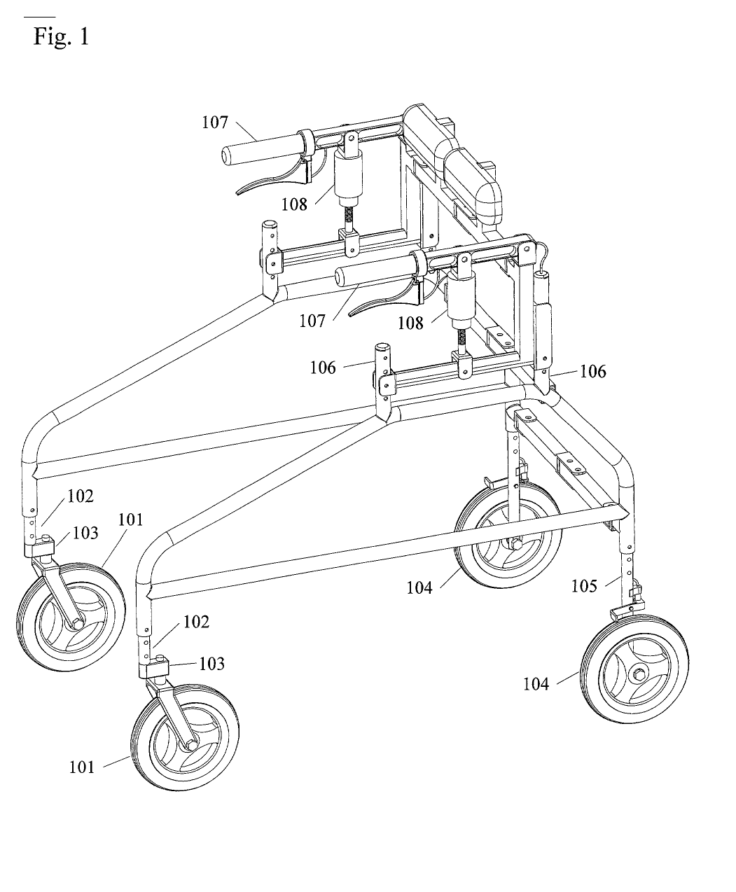

FIG. 1: Perspective view of the walker device

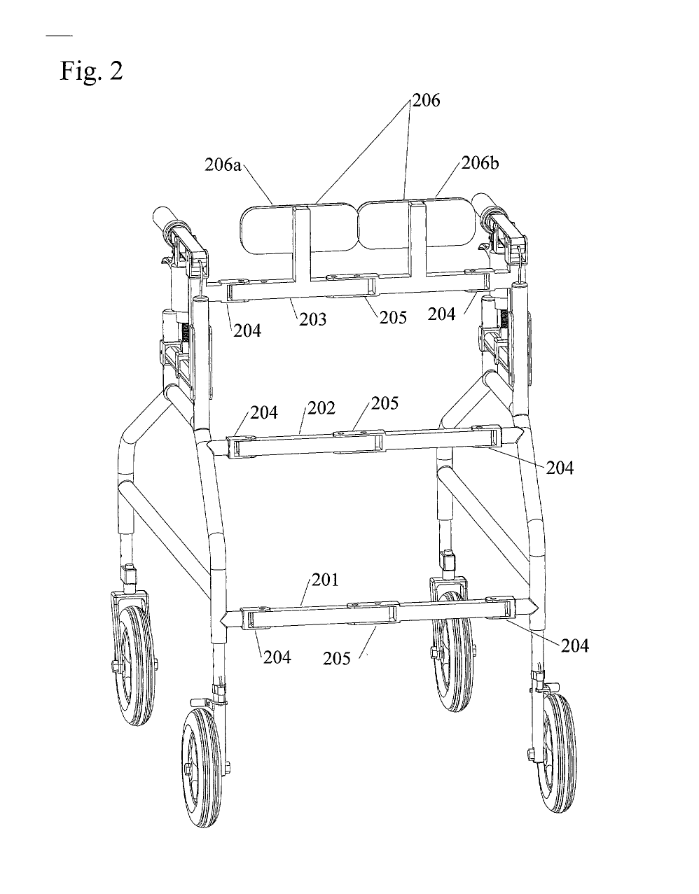

FIG. 2: Perspective view of the walker device as viewed from the back

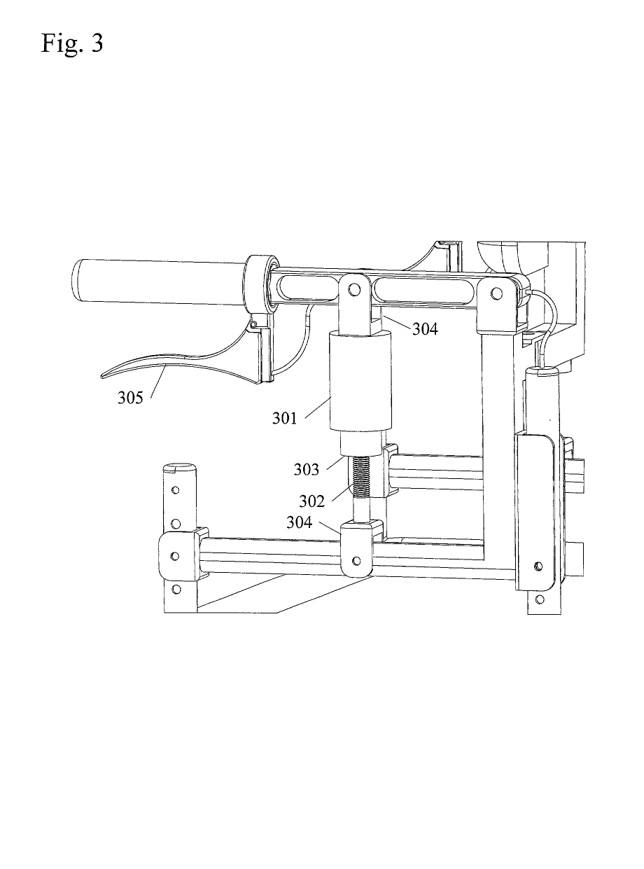

FIG. 3: Detailed view of the handle/spring component of the walker device

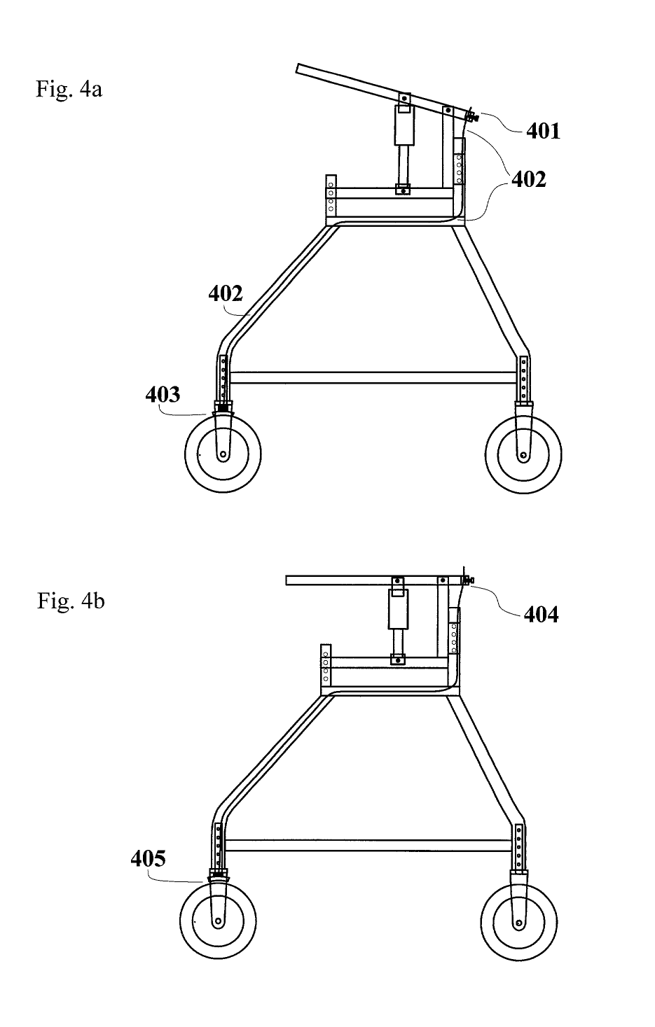

FIG. 4a & 4b: Side view of a walker in which the handle/spring component is linked with a wheel brake mechanism to help stabilize the walker when not loaded and to give additional tactile reenforcement for inadequate handle loading during use.

### DETAILED DESCRIPTION OF THE INVENTION

The rolling walker with load ensuring mechanism shall be described with reference to the previously outlined figures. The walker shown in FIG. 1 illustrates many of the advantageous features of the disclosed design. The front wheels of the walker (101) are linked to a height adjustable frame tubes (102) through a swiveling joint (103). The back wheels of the walker (104) are linked directly to similar height adjustable frame tubes (105) and therefore cannot swivel. This arrangement allows the walker user to navigate by pivoting the front of the walker towards their desired destination and proceeding forward. The non-swivelling back wheels help to prevent unwanted and potentially dangerous lateral translations of the walker.

Proper vertical fit of the walker to the user is important to insure correct usage of the device. A walker adjusted too high will result in elbow strain and inadequate lumbar support, while a walker adjusted too low will result in incorrect lumbar spinal positioning and strain. The present design allows for eight inches of vertical height adjustability through a combination of modification of wheel height tubes (102, 105) into the main frame and modification of the handle mounting assembly (106) onto the main frame. As the user loads the handles (107) in a downward direction, a spring within each of the piston housings (108) is compressed.

FIG. 2 shows the disclosed walker from a rear perspective. This view clearly illustrates the collapsible nature of the design. All three frame cross-members (201, 202, 203) function as stiff elements when they are in their locked positions. When compact storage of the walker is required, as in the situation of automobile transport, the frame cross-member may be unlocked so as to allow for free bending of the cross-member at points close to both main-frame tubes (204) and at a mid-cross-member point (205). The lumbar support pad (206) consists of two separate pads (206a,206b) so as to allow free bending at the mid-point of the cross-members during walker frame collapsing.

FIG. 3 shows an expanded view of the handle/piston component of the walker. The housing of the piston (301) is limited in its compression so as to yield a horizontal handle position when maximally compressed. A treaded rod (302) can be manually advanced further into the base of the piston housing so as to yield greater spring compression once the handle has been depressed to a horizontal position. In this way, prescribed patient loading amounts may be generated. Labels or color-coded bands may be included on the treaded rod to correlate with the loads required to reach handle horizontal positioning when the given thread indicator is advanced to the base of the piston (303). The piston is linked to both the handle and the frame body by pivoting joints (304) to allow for unrestricted handle movement. User-activated brakes may be activated through compression of brake handles (305) located at the end of the walker handles.

FIG. 4a and 4b shows a side profile view of a walker in which the piston/handle component has been linked to a braking mechanism on the front wheels. In this manner, the front wheels are immobile when either the handles are not being loaded or when the handles are loaded at a sub-required level. FIG. 4a shows a walker in a handle unloaded position. In this configuration, the back of the handle (401) is pivoted downward. A cable, running through the walker frame (402), connects the back of the handle to a spring loaded brake (403) on the front wheels. The excess cable generated by the pivoted handle allows the spring at the front wheel to push a brake pad into solid contact with the surface of the front wheel, thus braking the walker. In FIG. 4b, the same walker design is shown with a handle position that would correlate with application of an adequately large handle load. In this configuration, the brake cable has been pulled upward by the pivoting handle (404) and has correspondingly retracted the brake pad from the front wheel (405). Therefore, when a patient is getting into the walker and desires for it to be stationary, the patient would push against the body of the walker frame (not the handles).

What is claimed is:

1. A walker, comprising:
a structural framework to provide stability to four wheels, two handles and lumbar support pads,
a piston/spring system incorporated with said handles so as to provide a horizontal handle position only when a prescribed load or greater load is applied to said handles,
a piston/spring system incorporated with said handles so as to provide a non-horizontal handle position, thus discouraging usage, when a sub-critical load is applied to said handles,
an adjustment mechanism incorporated with said piston/spring system so as to provide a means for controlling the spring force required to depress said handle,
an adjustment mechanism incorporated with said piston/spring system so as to provide a means for easily calibrating the spring force required to depress said handle.

2. The walker of claim 1, wherein not only is a useful tactile feedback provided to the user by angulation of the walker's handles through application of an adequate applied load, but an additional cable/wheel brake assembly is integrated with the handle/spring system so as to yield braked wheels when an inadequate load is applied to said handles and correspondingly unbraked wheels when the prescribed load or greater loads are applied to said handles.

3. The walker of claim 1, wherein the adjustment mechanism to provide a means for controlling the spring force required to depress said handle may consist of a threaded rod that may be advanced further into the piston housing thus effectively pre-compressing the spring and therefore requiring greater patient handle loading to produce a horizontal handle position.

4. The walker of claim 1, wherein the springs housed within the pistons may be removed and be substituted for by one of a series of compressive springs of varying spring constant so as to yield varying ranges of prescribed handle loads to correspond to varying patient weights and clinical conditions.

5. The walker of claim 1, wherein the frame is capable of being collapsed so as to provide a configuration for convenient storage and transportation.

6. The walker of claim 1, wherein hand-activated brakes are added to the frame so as to provide user-generated wheel braking for the purpose of slowing the walker when used on a declined surface or stabilizing the walker while the user is entering or exiting the walker.
